(19) United States
(12) Patent Application Publication
(10) Pub. No.: US 2016/0099095 A1
(43) Pub. Date: Apr. 7, 2016

(54) RELEASABLE MAGNETIC DEVICE

(71) Applicant: I-BLADES, INC., Danville, CA (US)

(72) Inventors: Jorge Fernandes, Danville, CA (US); Paul Meissner, San Jose, CA (US); Peter C. Salmon, Mountain View, CA (US)

(21) Appl. No.: 14/876,517

(22) Filed: Oct. 6, 2015

Related U.S. Application Data
(60) Provisional application No. 62/060,595, filed on Oct. 7, 2014.
(60) Provisional application No. 62/060,562, filed on Oct. 6, 2014.

(51) Int. Cl. H01F 7/06; H01F 7/02

(52) U.S. Cl. CPC H01F 7/064; H01F 7/0252

(57) ABSTRACT

A magnetic device is described for releasably connecting a pair of assemblies; the device may serve as a mechanical connection or as an electrical connection, or both. The device comprises an inner core of high permeability material, a permanent magnet surrounding the inner core, and an outer excitation coil surrounding the permanent magnet. If the permeability of the high permeability material exceeds the permeability of the permanent magnet by a factor of at least 1,000, a manageable number of amp-turns in the excitation coil is capable of reversing the magnetic effect of the permanent magnet. The magnetic device can be miniaturized and provided in contact arrays suitable for coupling mobile devices.

### CROSS-REFERENCES TO RELATED APPLICATIONS

This application claims priority to U.S. Provisional Patent Application No. 62/060,595, filed on Oct. 7, 2014, entitled “Magnetic Contacting Array”, and U.S. Provisional Patent Application No. 62/060,562, filed on Oct. 6, 2014, entitled “Releasable Magnetic Device”, the disclosures of which are hereby incorporated by reference in their entirety for all purposes.

The following regular U.S. patent application is being filed concurrently with this one, and the entire disclosure of the other application is incorporated by reference into this application for all purposes: application Ser. No. ______, filed Oct. 6, 2015, entitled “MAGNETIC CONTACTING ARRAY” (Attorney Docket No. 93609-958382 (001910US).

### TECHNICAL FIELD

The present disclosure relates to a magnetic contacting array, and more particularly, to an adaptive magnetic contacting array. The present disclosure further relates to a releasable magnetic device, and a device incorporating the adaptive magnetic contacting array and releasable magnetic device.

### BACKGROUND OF THE INVENTION

Magnets have been used as electrical contactors in contact arrays. Such contact arrays have contributed to user convenience by not requiring any cables, nor any of their associated connectors. Despite the progress made in mobile devices and other electronic devices, there is a need in the art for improved devices as well as improved methods of connecting, disconnecting, modularizing, combining and producing them.

### SUMMARY OF THE INVENTION

Particularly with respect to mobile devices, it is desirable to contact a first magnetic array with a second magnetic array in an adaptive manner that is tolerant of manufacturing tolerances. It is further desirable to provide a convenient method for releasing a single magnet or a contact array comprising multiple magnets at a coupling interface in an automated context. Thus, the present disclosure relates to an adaptive magnetic contacting array and releasable magnetic device that can be used for these purposes.

An adaptive magnetic contacting device is described that comprises a plurality of magnets mounted on a flexible printed circuit board. The mounting configuration allows for local bending of the flexible printed circuit board at the point of attachment of each magnet, allowing for direct mating contact between magnetic arrays of devices despite manufacturing variances. The magnets may serve as a mechanical connection, an electrical connection, or both. In one embodiment, one or more of the magnets of the adaptive magnetic contacting device are releasable magnetic devices. In another embodiment, the adaptive magnetic contacting device can be used entirely separate from the releasable magnetic device.

An adaptive magnetic contacting device comprises a plurality of magnets mounted on a flexible printed circuit board. The mounting configuration allows local flexing of the flexible printed circuit board at the point of attachment of each magnet. The magnets are arrayed at an inner circle of the flexible printed circuit board, and an attachment to a second printed circuit board is provided at an outer circle. The contacting array provides isolation between a magnet on one side of the flex circuit and a corresponding contact pad on the other side of the flex circuit in one embodiment; in a stacked configuration of multiple devices having contact arrays, this supports isolation of upstream and downstream signals at each connection point of the coupling interface. In another embodiment, isolation is not provided between corresponding sides of the flex circuit. For example, one magnet could be used on both sides of the flex circuit, or two connected magnets could be used on either side of the flex circuit. The contacting device is adaptive because contact surfaces comprising magnet surfaces and corresponding contact pads can be pulled into direct mating contact, either planar or non-planar, owing to the mounting configuration and the flexibility of the flex circuit. Stacked assemblies comprising magnetic contacting arrays at each level of the stack are described, and also an attachment/detachment method comprising magnetic contacting arrays.

According to one embodiment, a magnetic contacting array is provided comprising a first printed circuit board including a first plurality of contact points; a plurality of flexible arms extending from the first printed circuit board including a second plurality of contact points; and a plurality of elements including at least one magnet attached to the second plurality of contact points. At least one contact point of the first plurality of contact points is electrically connected to a contact point of the second plurality of contact points.

According to another embodiment, a magnetic contacting array is provided comprising a first printed circuit board; a first plurality of contact points arrayed on a first surface of the first printed circuit board; a first plurality of elements including at least one first magnet attached to the first plurality of contact points; a second plurality of contact points arrayed opposing the first plurality of contact points on a second surface of the first printed circuit board; a second plurality of elements including at least one second magnet attached to the second plurality of contact points; a third plurality of contact points arrayed on the first surface of the first printed circuit board; and a fourth plurality of contact points arrayed opposing the third plurality of contact points on the second surface of the first printed circuit board. In one embodiment, the first plurality of contact points are electrically isolated from the second plurality of contact points. In the same or another embodiment, at least one contact point of the third plurality of contact points is electrically connected to a contact point of the first plurality of contact points.

A magnetic device is also described for releasably connecting a pair of assemblies; the device may serve as a mechanical connection or as an electrical connection, or both. The device comprises an inner core of high permeability material, a permanent magnet surrounding the inner core, and an outer excitation coil surrounding the permanent magnet. If the permeability of the high permeability material exceeds the permeability of the permanent magnet, for example, by a factor of at least 1,000, a manageable number of amp-turns in the excitation coil is capable of reversing the magnetic effect of the permanent magnet. The magnetic device can be miniaturized and provided in contact arrays suitable for coupling mobile devices, such as those described herein. It can be configured to support high current such as 5 amperes, and high data rates such as 500 Mbps.

According to one embodiment, a releasable magnetic device is provided that comprises a core of high permeability material; a permanent magnet surrounding the core of high permeability material; an excitation coil; a coil driver electrically connected to the excitation coil; a processor configured to activate the excitation coil by driving current through the coil driver; and a memory containing instructions executable by the processor to activate the excitation coil.

According to another embodiment, a contact interface is provided that comprises a first coupling magnet and a second coupling magnet. The first coupling magnet comprises a core of high permeability material; a permanent magnet surrounding the core of high permeability material; an excitation coil; a coil driver electrically connected to the excitation coil; a processor configured to activate the excitation coil by driving current through the coil driver; and a memory containing instructions executable by the processor to activate the excitation coil. The first coupling magnet and the second coupling magnet are coupled at a planar coupling interface when the excitation coil is not activated. The first coupling magnet and the second coupling magnet are uncoupled when the excitation coil is activated.

A method for coupling and uncoupling devices is also described. The method comprises providing a first device comprising a first magnet; providing a second device comprising a core of high permeability material, a second magnet surrounding the core of high permeability material, and an excitation coil; coupling the first device to the second device by magnetic attraction between the first magnet and the second magnet; and activating the excitation coil to uncouple the first device from the second device by a reduction in the magnetic attraction and/or magnetic repulsion between the first magnet and the excitation coil.

A magnetic contacting array incorporating one or more releasable magnetic devices as elements in the contacting array is also provided.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claims.

The foregoing, together with other features and embodiments, will become more apparently upon referring to the following specification, claims, and accompanying drawings.

### BRIEF DESCRIPTION OF THE DRAWINGS

Illustrative embodiments of the present invention are described in detail below with reference to the following drawing figures:

FIG. 1 is a top view of a magnetic contacting array.

FIG. 2A is an expanded schematic view of a segment of the magnetic contacting array of FIG. 1.

FIG. 2B is another expanded schematic view of a segment of the magnetic contacting array of FIG. 1.

FIG. 3 is an expanded cross-sectional view of a stacked assembly of magnetic contacting arrays.

FIG. 4 is another cross-sectional view of a stacked assembly of magnetic contacting arrays.

FIG. 5A is a top view of a magnetic contacting array having arms.

FIG. 5B is another top view of a magnetic contacting array having arms.

FIG. 6 is another top view of a magnetic contacting array having arms.

FIG. 7A is a top view of a case having a magnetic contacting array with locks.

FIG. 7B is a top view of a case having a magnetic contacting array with a lock.

FIG. 8 is a cross-sectional view of a magnetic contacting array.

FIG. 9 is another cross-sectional view of a magnetic contacting array.

FIG. 10 is another cross-sectional view of a magnetic contacting array.

FIG. 11 is another cross-sectional view of a magnetic contacting array.

FIG. 12 is a top view of a magnetic contacting array.

FIG. 13 is a flow chart of a method for attaching devices.

FIG. 14 is an expanded schematic view of a releasable magnetic device.

FIG. 15 is a schematic view of a contact interface comprising a first coupling magnet, a second coupling magnet that is releasable, and a planar interface between them.

FIG. 16 is a top view of a contact array comprising a plurality of releasable magnets.

FIG. 17 is a flow chart of a method for coupling and uncoupling devices.

### DETAILED DESCRIPTION OF SPECIFIC EMBODIMENTS

In the following description, for the purposes of explanation, specific details are set forth in order to provide a thorough understanding of embodiments of the invention. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

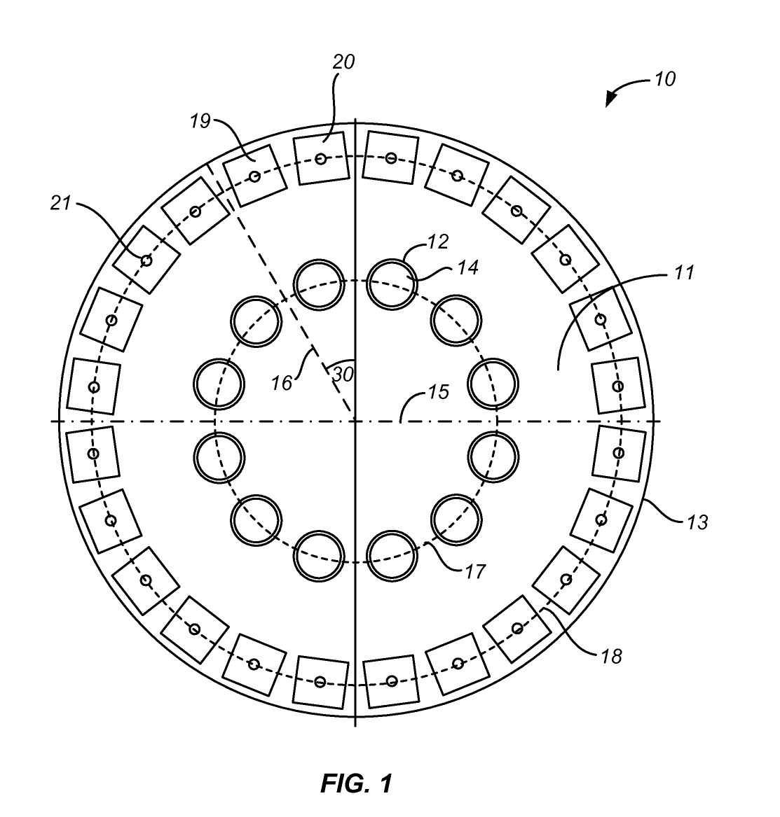

FIG. 1 illustrates the top surface 11 of a magnetic contacting array 10, including a first set of contact pads 12 fabricated on a flexible printed circuit board 13, and a matching set of magnets 14 attached to the contact pads 12 using conductive epoxy or the like. Magnets 14 may also be attached to contact pads 12 by other methods, including ultrasonic bonding and low temperature soldering as examples. A second set of contact pads matching contact pads 12 is provided on the reverse side of flexible circuit board 13, to be further described. In one embodiment, magnets 14 are neodymium magnets comprising an alloy of NdFeB with a grade of N42M or better for use in consumer product applications at temperatures up to 100° C. However, it is noted that higher temperatures grades up to 200° C. are available for more demanding environments. A complete contact array of magnets 14, in this case 12 magnets, have a breakaway force of 1-3 pounds in one embodiment when coupled with a similar matching array. The magnetic axis of magnets 14 is preferably perpendicular to the local region of flexible printed circuit board 13 on which each magnet is mounted, and the polarity of each magnet in each adjacent pair of the contact array is preferably reversed. This reversing of polarity of adjacent magnets has the effect of reducing the far field magnetic effect of the magnetic contacting array, which may avoid unwanted disturbance of sensitive magnetic instruments in mobile devices, for example. In addition, such a configuration allows for polarity pairing of magnets to ensure that the magnets only connect with the proper polarity.

Magnetic contacting array 10 is shown with symmetry about center line 15. Segment 16 has a subtended angle of 30 degrees in FIG. 1, and represents 12-fold symmetry about a center axis of the contact array. The 12-fold symmetry is just one example, however, and it is contemplated that the symmetry could be more or less than 12-fold. For each contact pad 12 shown at inner circle 17, two contacts are provided in a third set of contact pads at outer circle 18; these contacts are referred to as a left contact pad 19 and a right contact pad 20 in each segment 16. A fourth set of contact pads is provided on the reverse side of flexible printed circuit board 13, matching the third set of contact pads such as 19, to be further described. A plated through hole 21 is provided in this embodiment at each of the third set of contact pads.

Although shown and described in FIG. 1 as being separate from flexible printed circuit board 13, it is contemplated that any of the contact pads described above and herein can be integral with flexible printed circuit board 13, and contact points on the flexible printed circuit board 13 can instead be utilized. In other words, it is contemplated that magnetic contacting array 10 can be formed of a single piece of flexible printed circuit board 13 with magnets 14 positioned thereon at particular contact points.

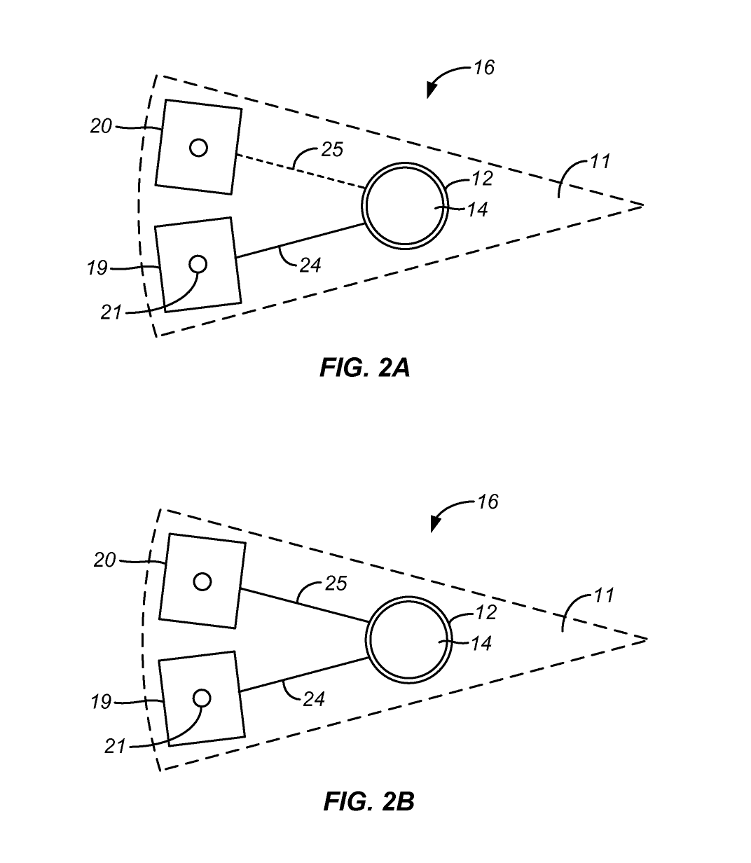

FIG. 2A depicts an enlarged schematic view of segment 16 of FIG. 1. Left contact pad 19, right contact pad 20, and feedthrough 21 are shown, together with first contact pad 12 and magnet 14. On the top surface 11 of flexible printed circuit board 13, trace 24 connects between left contact pad 19 and contact pad 12. On the bottom surface of printed circuit board 13, trace 25 connects between a contact pad of the second set of contact pads, and a corresponding contact pad of the fourth set of contact pads. In other words, the first and second sets of contact pads are electrically isolated from each other in this embodiment, allowing for two different functionalities, if so desired.

FIG. 2B depicts an enlarged schematic view of segment 16 of FIG. 1 according to another embodiment. On the top surface 11 of flexible printed circuit board 13, trace 24 connects between left contact pad 19 and contact pad 12. Also on the top surface 11 of flexible printed circuit board 13, trace 25 connects between right contact pad 20 and contact pad 12. In this embodiment, traces 24 and 25 provide for high current density.

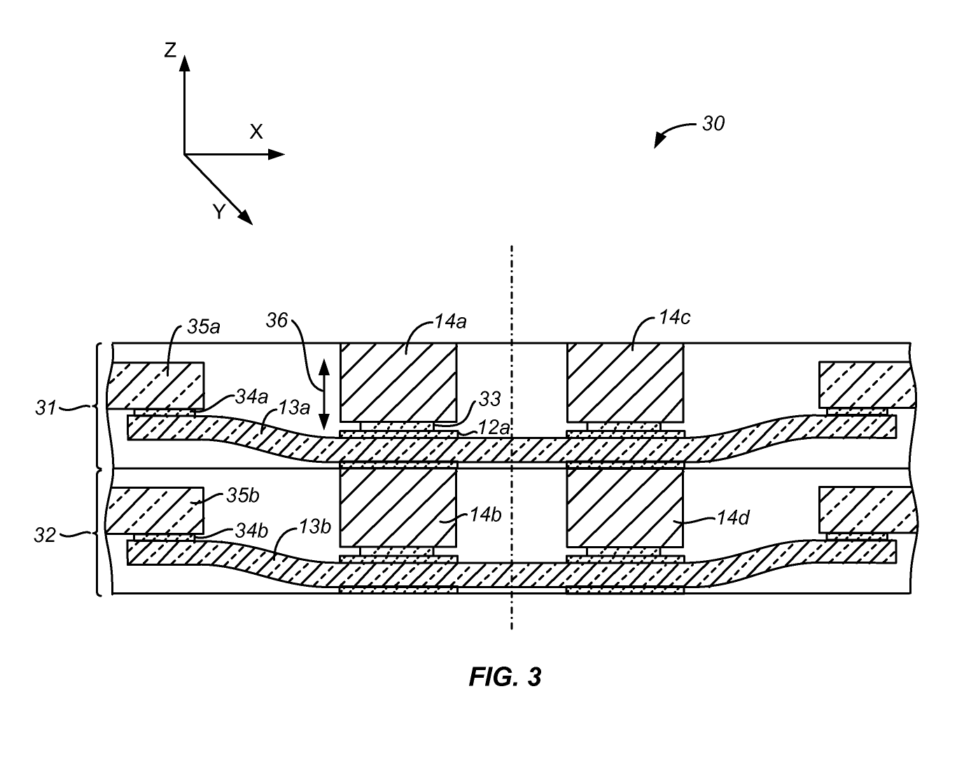

FIG. 3 illustrates in cross-section a stacked assembly 30 comprising device 31 and device 32, each of device 31 and device 32 comprising a magnetic contacting array such as 10 described in reference to FIG. 1. Magnets 14a, 14b, 14c and 14d are shown. Flexible printed circuit boards 13a and 13b are also shown. Magnet 14a connects electrically with a trace (not shown) of flexible printed circuit board 13 via conductive epoxy 33, for example, and contact pad 12a. The trace connects further with contact pad 34a and from there to a trace (not shown) of second printed circuit board 35 which further connects to a pin of a driver circuit, to be described further herein. Bidirectional arrow 36 indicates that the mounting of magnet 14a in device 31 comprises a floating characteristic, wherein the exact location of magnet 14a after coupling with magnet 14b can vary in the z-direction (by at least 1 mm, in one embodiment), and also can vary slightly in the x- and y-directions, due in part to the flexible characteristic of flexible printed circuit board 13. The potential for substantial adjustments in the z-direction supports an adaptive magnetic contacting array which can adjust to manufacturing tolerances observed in devices 31 and 32, for example. Accordingly, good electrical contact can be provided between corresponding control points 34a and 34b, supporting currents of at least 2 amperes and data rates of at least 400 Mbps between these points, for example.

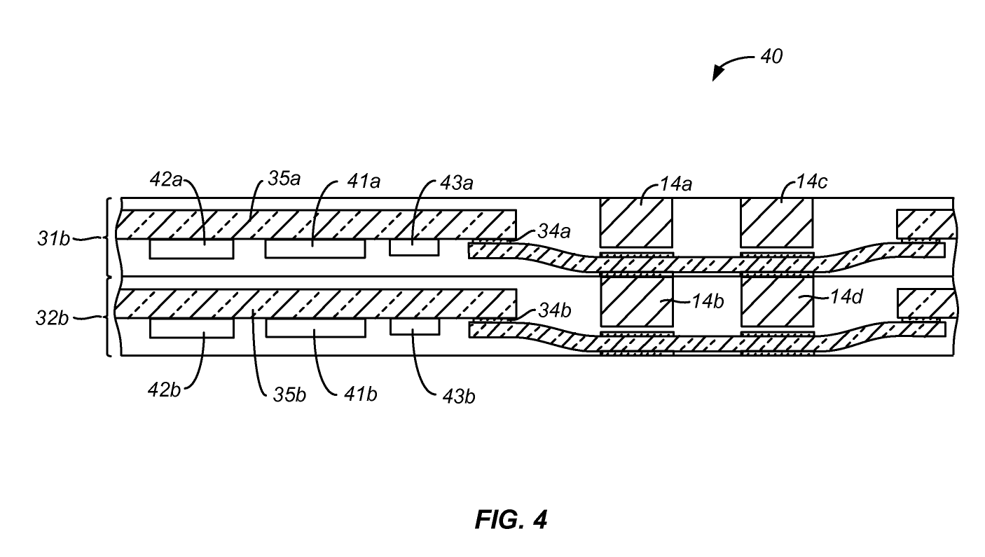

FIG. 4 is similar to FIG. 3, except that additional components are shown attached to second printed circuit boards 35a and 35b. In this embodiment, second printed circuits boards 35a and 35b are rigid circuit boards, but can be flexible in another embodiment. In one example, second printed circuit boards 35a and 35b have a thickness of around 0.031 inches and support around 6 trace layers, including conductive planes in support of controlled impedance traces for high speed routing of signals. The additional components may include processors 41a, 41b; memories 42a, 42b; and drivers 43a, 43b. Instructions in memory device 42a may be executable by processor 41a to control driver chip 43a, such that control point 34a is properly connected to an element of the magnetic contacting array for transmission of an upstream or downstream signal, for example. An upstream signal is routed from the contacting array to the processor, while a downstream signal is routed from the processor to the contacting array, and potentially from there to another device in a stack of devices.

Although shown as described as being separate from and in addition to flexible printed circuit boards 13a and 13b in FIGS. 3 and 4, it is contemplated that second printed circuit boards 35a and 35b can be entirely eliminated from one or both of devices 31 and 32 in one embodiment. For example, a single piece of flexible printed circuit board 13a can be used in device 31 or 31b in place of both flexible printed circuit board 13a and second printed circuit board 35a. In this embodiment, flexible printed circuit board 13a connects directly to processor 41a, memory 42a, and driver chip 43a. A similar configuration can be used in device 32.

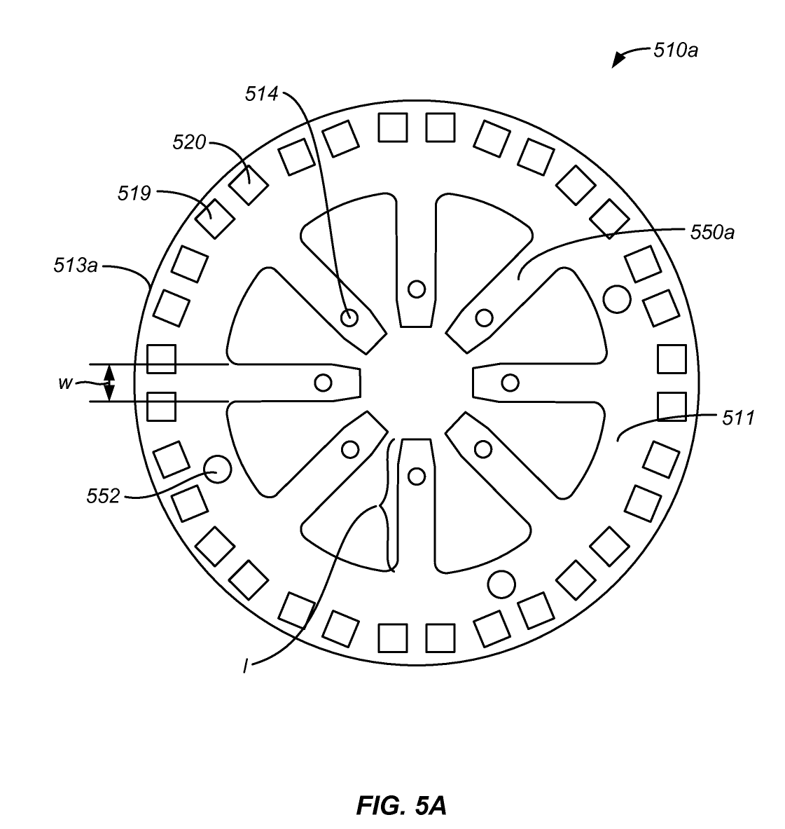

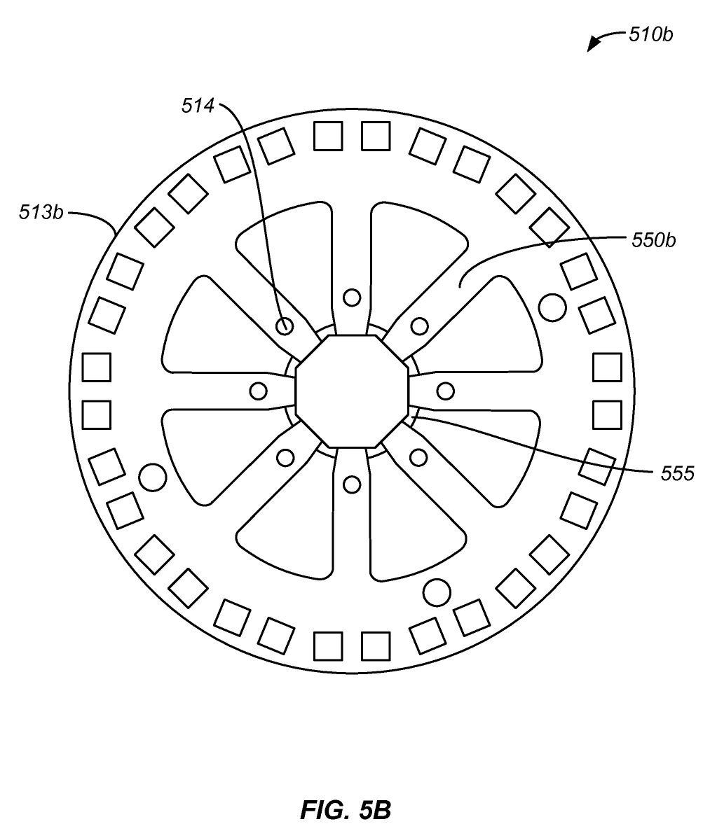

FIG. 5A is a top view of a magnetic contacting array 510a having arms 550a, but can otherwise be similar in design and function to any of the other embodiments of magnetic contacting arrays described herein. Contact pads 519, 520 are positioned at an outer edge of a top surface 511 of flexible printed circuit board 513a. Arms 550a, having length l and width w, extend inward with respect to contact pads 519 and terminate in magnets 514. Although shown as being similar in length l and width w, it is contemplated that arms 550a may be of any length or width entirely independent of one another. Further, although shown and described as extending inward, it is contemplated that arms 550a may originate in the middle of magnetic contacting array 510a and extend outward instead.

Because arms 550a are made of flexible materials, they are able to move to a certain degree, depending on the length l and width w of the arms 550a, as well as on the rigidity and thickness of flexible printed circuit board 513, as described further herein. In this embodiment, three reference holes 552 are also provided between arms 550a and contact pads 519, 520. However, it is contemplated that reference holes 552 can be provided in any position on contacting array 510a and can be of any size or shape, or can be eliminated entirely. In this embodiment, reference holes 552 are provided for manufacturing purposes to properly place magnets 514 on arms 550a and/or to align magnetic contacting array 510a in a case or housing. In other embodiments, reference holes 552 are not necessary and other tools may be used for alignment during the manufacturing processes, such as a tool with mounted magnets to force magnets 514 into alignment.

FIG. 5B illustrates another embodiment of magnetic contacting array 510b having arms 550b. In this embodiment, however, arms 550b are connected at their innermost points by a ring 555. Ring 555 can either be integral with or separate from flexible printed circuit board 513b, and made of the same or a separate material. According to this embodiment, the flexibility of arms 550b is restricted, limiting full movement of arms 550b. This embodiment avoids jamming of the magnets 514 caused by the potential for unwanted angular movement of arms 550b when given their maximum flexibility.

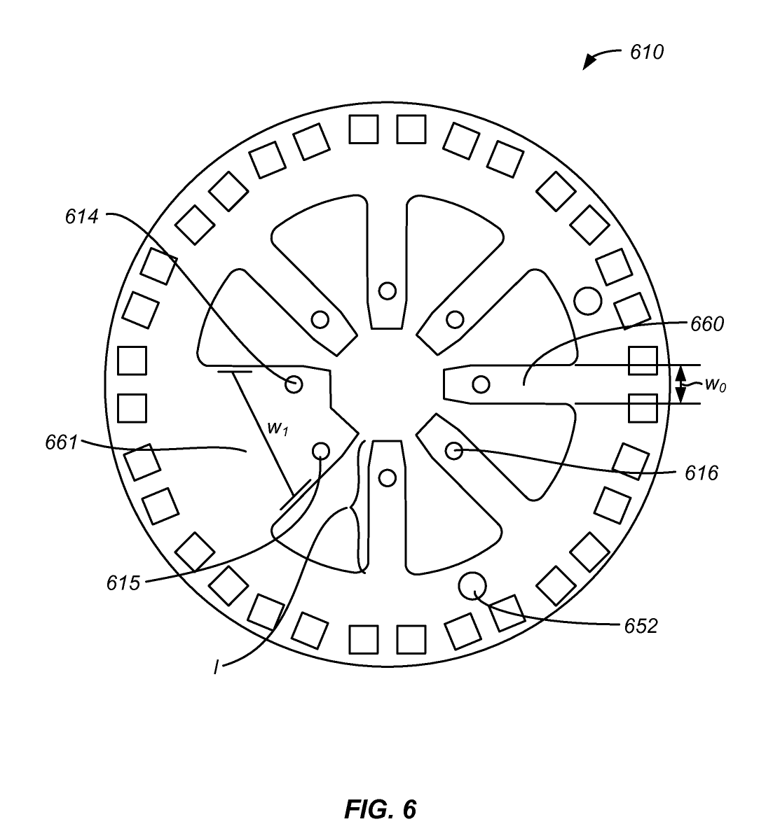

FIG. 6 illustrates a further embodiment in which magnetic contacting array 610 has an arm 661 with increased width with respect to arm 660. Although arms 660, 661 are equal in length 1, arm 661 has a width w₁ which is greater than the width w₀ of arm 660. Because arm 661 has an increased width w₁, arm 661 is more stable and less flexible than arm 660. Further, arm 661 terminates in two magnets 614, 615, whereas arm 660 terminates in one magnet 616. Thus, arm 661 can accommodate a greater amount of current than arm 660. Otherwise, magnetic contacting array 610 can be similar in design and function to any of the other embodiments of magnetic contacting arrays described herein. In this embodiment, one reference hole 652 is also provided, which can be used as described with respect to reference holes 552 of FIG. 5A. In another embodiment, reference hole 652 can be omitted entirely.

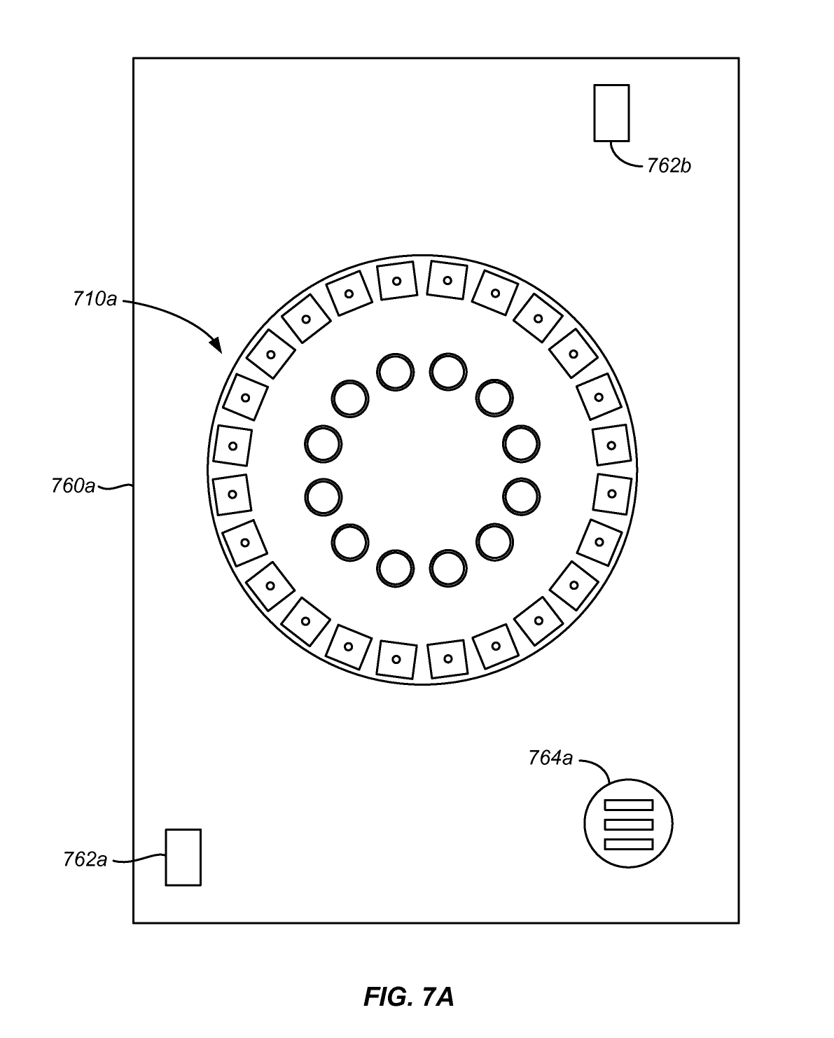

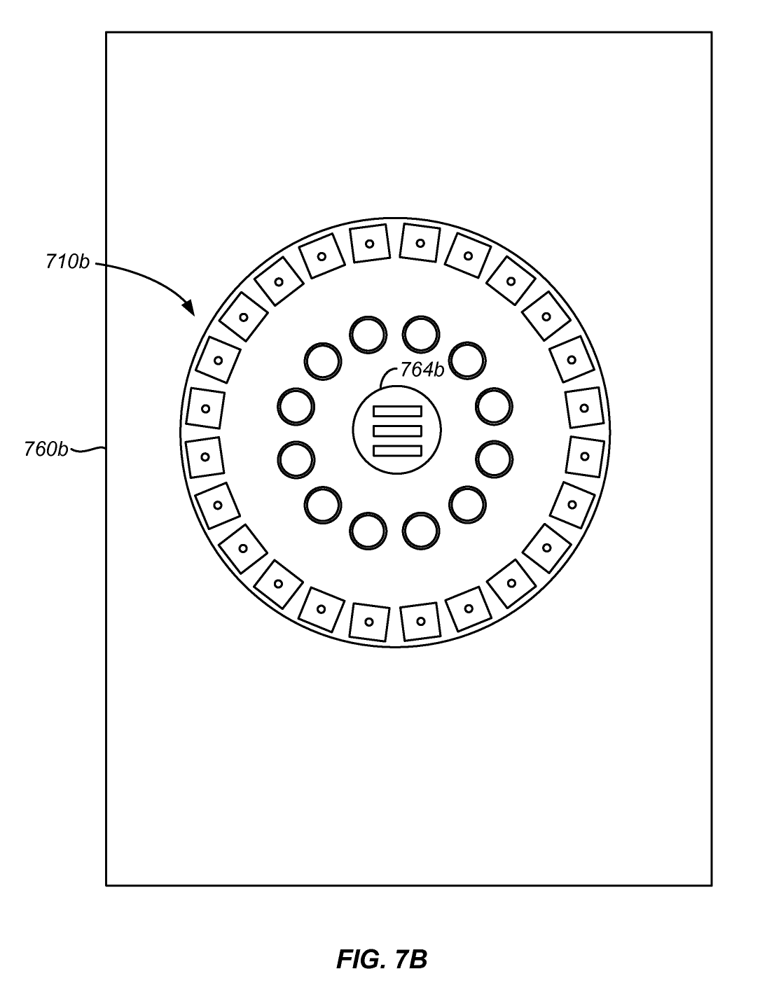

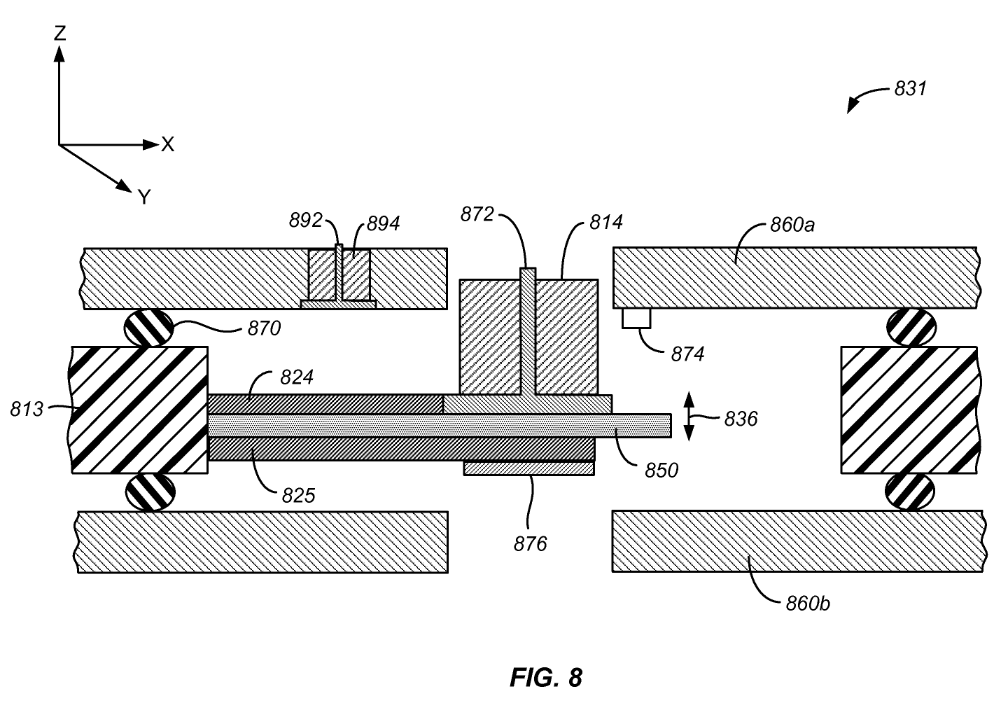

FIGS. 7A and 7B illustrate cases 760a, 760b integrating magnetic contacting arrays 710a, 710b, respectively. Magnetic contacting arrays 710a, 710b may be any of the magnetic contacting arrays described herein. Case 760a includes two manual locks 762a, 762b and one mechanical lock 764a, but can include any type or number of either lock. Manual locks 762a, 762b can comprise permanent or dynamic magnets, for example, which form a magnetic connection with magnets on other devices, locking the devices together and in place. A dynamic magnet is, for example, a magnet in which the magnetic field is generated by an electrical current flowing into a coil wrapped around a core. Mechanical lock 764a can be any type of suitable lock, such as, for example, a fixed male-female mating lock. The male-female mating lock may comprise, for example, a male portion moving into the female portion due to magnetic force; a magnetic field or pressure applied to a sideways pin to push into a second pin on the male portion; or a rotating screw extending into a female portion. Another example of a suitable mechanical lock 764a is a clamp on one side extending over a magnet on the other side, providing both a physical and a magnetic lock. Although shown in FIG. 7A in particular positions and locations, it is contemplated that locks 762a, 762b and 764a can be positioned or distributed anywhere on case 760a or magnetic contacting array 710a. For example, lock 762b can be positioned centrally just above magnetic contacting array 710a. Further, locks 762a, 762b and 764a can all be of the same type. In one example, one or all of locks 762a, 762b and 764a comprise pin-mounted magnets, similar to how magnet 814 is mounted with pin 872 in FIG. 8, described herein.

In another example, lock 764b of FIG. 7B is positioned at the center of magnetic contacting array 710b, and can be a mechanical lock, fixed magnet, dynamic magnet, and/or a manual lock. In one embodiment, lock 764b is an electromagnetic lock that acts as an activation magnet for magnetic contacting array 710b. In this embodiment, the activation magnet can comprise a physical or magnetic switch that activates the magnetic contacting array 710b. Although shown and described as particular shapes and sizes, it is contemplated that locks 762a, 762b, 764a and 764b can be of any shape and/or size.

FIG. 8 is a cross-sectional view of a device 831 having a magnetic contacting array according to one embodiment. The magnetic contacting array shown in FIG. 8 can be any of the magnetic contacting arrays described herein. The magnetic contacting array is housed between a case top 860a and a case bottom 860b. Case top 860a and case bottom 860b together form a case or housing for the magnetic contacting array or a mobile device, for example. In this embodiment, case top 860a incorporates a lock comprising a magnet 894 mounted to a pin 892. Pin 892 can be pre-formed or post-formed, as described further herein with respect to pin 872. Magnet 894 can form a magnetic connection with magnets on other devices, locking the devices together and in place. Together, magnet 894 and pin 892 can correspond to manual locks 762a and/or 762b of FIG. 7A, for example.

From flexible printed circuit board 813 extends flexible printed circuit board arm 850. Flexible printed circuit board arm 850 can be made of the same material as flexible printed circuit board 813, and can either be separate from and bonded to flexible printed circuit board 813, or integral with flexible circuit board 813 (i.e., flexible printed circuit board 813 and flexible printed circuit board arm 850 can be formed from a single piece of flexible printed circuit board material).

A water seal 870 is provided between flexible printed circuit board 813 and case top 860a, as well as between flexible printed circuit board 813 and case bottom 860b in this embodiment. Water seal 870 can provide a barrier between any fluid entering case top 860a and case top 860b and any or all mechanical, electrical, magnetic, or any other components, including the electronic components of the magnetic contacting array, such as the memory, processor and driver shown in FIG. 4, for example. However, it is contemplated that water seal 870 can be entirely omitted in other embodiments.

Magnet 814 is shown with a hole (not labeled). Magnet 814 connects electrically with top trace 824 of flexible printed circuit board 813 via pin 872 through the hole. Pin 872 can be pre-formed, soldered and positioned as shown in FIG. 8 in one embodiment. In another embodiment, pin 872 is post-formed. For example, magnet 814 can be placed on a conductive base on flexible printed circuit board arm 850 in contact with top trace 824, then a conductive epoxy (or other suitable conductive adhesive) is squeezed through the hole of magnet 814 to form pin 872. In another example, conductive epoxy can be placed on flexible printed circuit board arm 850 in contact with top trace 824, then magnet 814 can be pressed into it, causing the conductive epoxy to be wicked up through the hole.

Although shown as slightly protruding from magnet 814, it is contemplated that pin 872 can be recessed within magnet 814, or may that pin 872 may not be formed at all. In another embodiment, pin 872 can be flush with magnet 814 such that magnet 814 can make flush contact with another device, such as is shown in FIGS. 3 and 4. In this embodiment, electrical conduction comes through pin 872 holding magnet 814, and magnet 814 merely provides mechanical attraction. In other embodiments, however, pin 872 can merely be a mechanical hold for magnet 814, the latter of which provides the electrical connection. This pin embodiment can be combined with any of the other embodiments described herein as a means to affix a magnet to a flexible arm, to electrically connected a magnet to a trace and/or to provide a lock, as examples.

In one embodiment, top trace 824 connects further with a contact pad (not shown), and from there to a trace of a second printed circuit board (not shown), such as second printed circuit board 35a of FIGS. 3 and 4. The second printed circuit board further connects to the pin of a driver circuit. In another embodiment, top trace 824 connects directly to the flexible printed circuit board, which connects directly to the pin of a driver circuit.

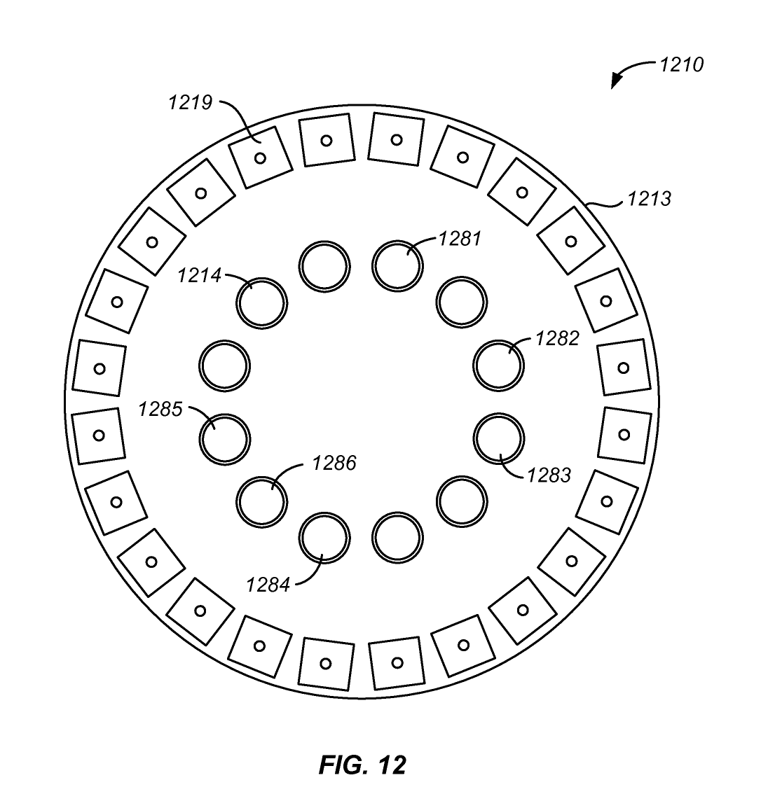

A bottom trace 825 is also provided opposite to top trace 824 on flexible printed circuit board arm 850, facing case bottom 860b. Bottom trace 825 is coupled to conductive surface 876, which can be an electrode, for example. However, it is contemplated that conductive surface 876 can be any of a number of alternatives, such as is described further herein with respect to FIG. 12. Bottom trace 825 can also be electrically connected to the pin of the same or a different driver circuit.

Bidirectional arrow 836 indicates that the mounting of magnet 814 comprises a floating characteristic, wherein the exact location of magnet 814 after coupling with another magnet (not shown) can vary in the z-direction (by at least 1 mm, in one embodiment). The movement of magnet 814 is limited by a stop 874 in this embodiment. The location or position of magnet 814 also can vary slightly in the x- and y-directions, due in part to the flexible characteristic of flexible printed circuit board 813 and flexible printed circuit board arm 850. To prevent jamming of magnet 814 due to unwanted angular movement, it is contemplated that a ring can be provided connecting flexible printed circuit board arm 850 to the other flexible printed circuit board arms (not shown) of the magnetic contacting array, such as is shown and described in FIG. 5B.

The potential for substantial adjustments in the z-direction supports an adaptive magnetic contacting array which can adjust to manufacturing tolerances observed in device 831, for example. Accordingly, good electrical contact can be provided between stacked devices, as shown in FIGS. 3 and 4, supporting currents of at least 2 amperes and data rates of at least 400 Mbps, in one example.

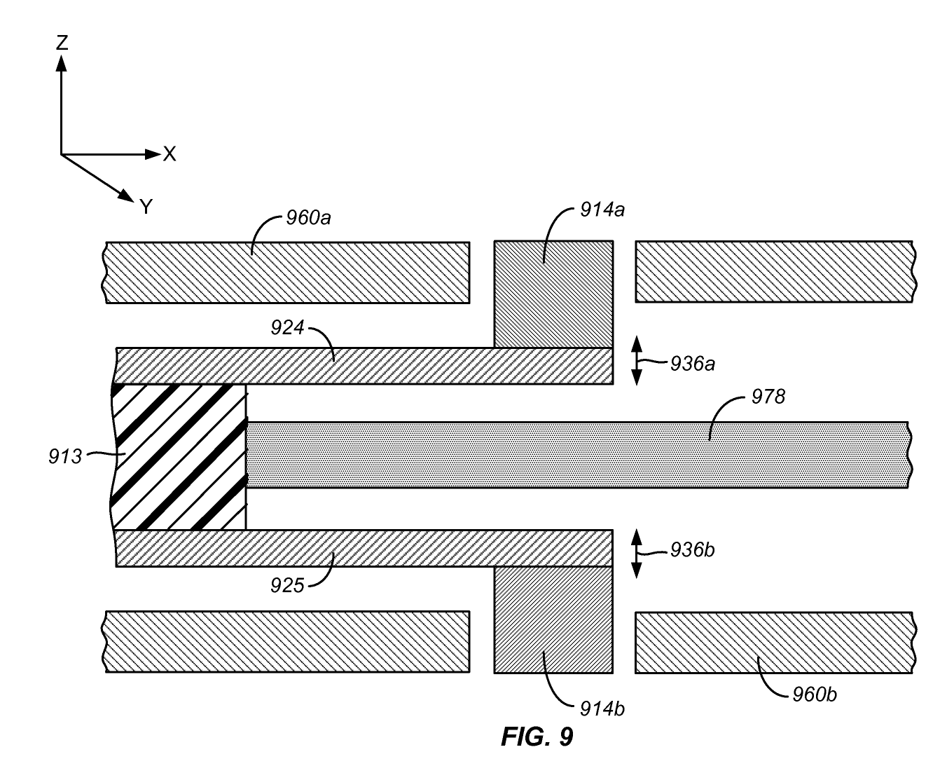

FIG. 9 is a cross-sectional view of a device 931 having a two-sided magnetic contacting array according to another embodiment. The magnetic contacting array can be any of the magnetic contacting arrays described herein. In this embodiment, printed circuit board 913 is provided between a case top 960a and case bottom 960b. Printed circuit board 913 can be flexible or rigid. A top trace 924 also serves as an arm flexibly supporting magnet 914a. Similarly, a bottom trace 925 also serves as an arm flexibly supporting magnet 914b. Flexible printed circuit board arms are not needed in this embodiment, and thus are omitted. Unlike FIG. 8, magnets 914a, 914b are provided on both sides of device 931, with a magnetic shield 978 between them to isolate their respective magnetic fields from each other. However, it is contemplated that any of a number of alternatives may replace magnet 914a and/or magnet 914b, as described further herein with respect to FIG. 12. Further, any of a number of alternatives may replace magnetic shield 978, such as, for example, a battery that provides additional battery life for a mobile device. As another example, a payment device that interacts with existing point of sale systems may replace magnetic shield 978.

Top trace 924 connects further with a contact pad (not shown), and from there to a trace of a second printed circuit board (not shown), such as second printed circuit board 35a of FIGS. 3 and 4. The second printed circuit board further connects to the pin of a driver circuit. Similarly, bottom trace 925 can be electrically connected to the same or a different driver circuit. In another embodiment, top trace 924 and bottom trace 925 connect to the flexible printed circuit board, which connects directly to the driver circuit.

Again, bidirectional arrows 936a, 936b indicate that the mounting of magnets 914a, 914b on top trace 924 and bottom trace 925, respectively, comprises a floating characteristic, wherein the exact location of magnets 914a, 914b after coupling with another magnet (not shown) can vary in the z-direction (by at least 1 mm, in one embodiment). The location or position of magnets 914a, 914b can also vary slightly in the x- and y-directions, due in part to the flexible characteristic of top trace 924 and bottom trace 925. To prevent jamming of magnets 914a, 914b due to unwanted angular movement, it is contemplated that a ring of insulating material can be provided connecting top trace 924 to the other top traces (not shown) of the magnetic contacting array, and/or connecting bottom trace 925 to the other bottom traces (not shown) of the magnetic contacting array, such as is shown and described with respect to FIG. 5B.

The potential for substantial adjustments in the z-direction supports an adaptive magnetic contacting array which can adjust to manufacturing tolerances observed in device 931, for example. Accordingly, good electrical contact can be provided between stacked devices, as shown in FIGS. 3 and 4, supporting currents of at least 2 amperes and data rates of at least 400 Mbps, in one example.

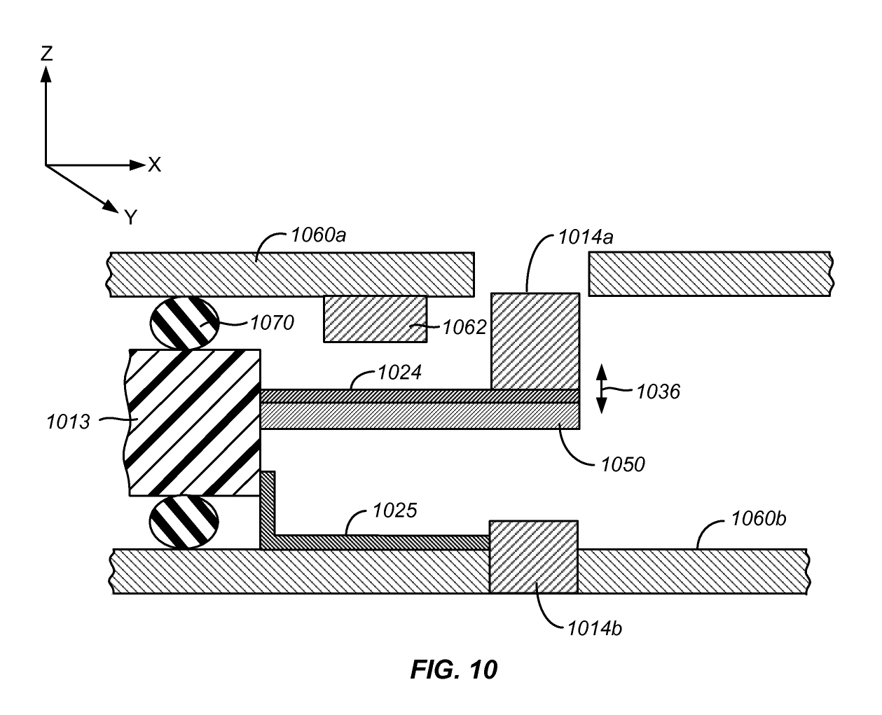

FIG. 10 is a cross-sectional view of a device 1031 having a magnetic contacting array utilizing a moving magnet 1014a and a static magnet 1014b according to another embodiment. The magnetic contacting array can be any of the magnetic contacting arrays described herein. In this embodiment, printed circuit board 1013 is provided between a case top 1060a and a case bottom 1060b. Printed circuit board 1013 can be flexible and integral with flexible arm 1050, or rigid and made from a separate material than flexible arm 1050. A top trace 1024 is provided between flexible arm 1050 and magnet 1014a, with magnet 1014a being in electrical contact with top trace 1024. Magnet 1014a can make electrical contact with top trace 1024 by any suitable means. For example, a cup may be presoldered to top trace 1024 of flexible arm 1050; conductive adhesive may be added to the cup; then the magnet may be placed on top of the conductive adhesive. If magnet 1014a is dynamic, however, magnet 1014a can be soldered directly to top trace 1024. In another embodiment, magnet 1014a can be electrically connected to top trace 1024 via a pin, such as is described with respect to FIG. 8. Top trace 1024 connects further with a contact pad (not shown), and from there to a trace of a second printed circuit board (not shown), such as second printed circuit board 35a of FIGS. 3 and 4. The second printed circuit board further connects to the pin of a driver circuit.

Again, bidirectional arrow 1036 indicates that the mounting of magnet 1014a on flexible arm 1050 comprises a floating characteristic, wherein the exact location of magnet 1014a after coupling with another magnet (not shown) can vary in the z-direction (by at least 1 mm, in one embodiment). The location or position of magnet 1014a can also vary slightly in the x- and y-directions, due in part to the flexible characteristic of flexible arm 1050. To prevent jamming of magnet 1014a due to unwanted angular movement, it is contemplated that a ring of material can be provided connecting flexible arm 1050 to other flexible arms (not shown) of the magnetic contacting array, such as is shown and described with respect to FIG. 5B.

The potential for substantial adjustments of magnet 1014a in the z-direction supports an adaptive magnetic contacting array which can adjust to manufacturing tolerances observed in device 1031, for example. Accordingly, good electrical contact can be provided between stacked devices, as shown in FIGS. 3 and 4, supporting currents of at least 2 amperes and data rates of at least 400 Mbps, in one example.

A bottom trace 1025 is also provided between printed circuit board 1013 and a static magnet 1014b, which does not move in the x-, y- or z-directions. Bottom trace 1025 can be electrically connected to the same or a different driver circuit than top trace 1024. Magnet 1014b can also support currents of at least 2 amperes and data rates of at least 400 Mbps, in one embodiment. However, it is contemplated that any of a number of alternatives may replace magnet 1014a and/or magnet 1014b, as described further herein with respect to FIG. 12.

A water seal 1070 is provided between flexible printed circuit board 1013 and case top 1060a, as well as between flexible printed circuit board 1013 and case bottom 1060b in this embodiment. Water seal 1070 can provide a barrier between any fluid entering case top 1060a and case top 1060b and any mechanical, electronic, magnetic or other components, such as, for example, the electronic components of the magnetic contacting array, such as the memory, processor and driver shown in FIG. 4. However, it is contemplated that water seal 1070 can be omitted in other embodiments.

In an optional embodiment, an additional element (not shown) may be added between flexible arm 1050 and static magnet 1014b, such as, for example, a magnetic shield as shown and described with respect to FIG. 9. As another example, a battery can be provided connected to printed circuit board 1013 between flexible arm 1050 and bottom trace 1025 to provide further battery life to a mobile device. However, any other alternative element described herein can be integrated into the embodiment shown in FIG. 10.

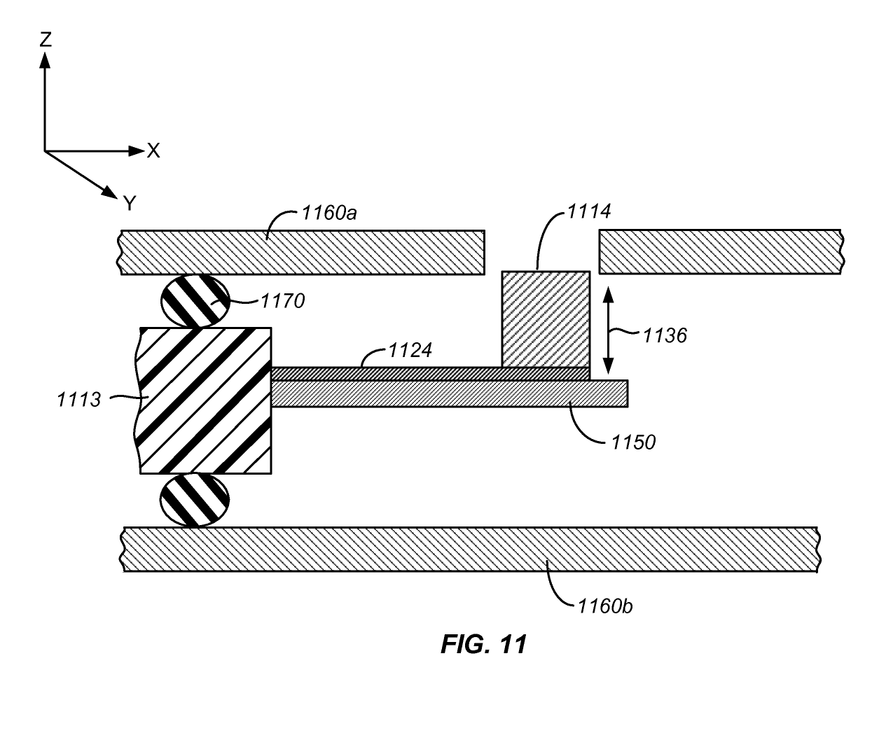

FIG. 11 is a cross-sectional view of a device 1131 having a one-sided magnetic contacting array according to an embodiment. The magnetic contacting array can be any of the magnetic contacting arrays described herein. In this embodiment, printed circuit board 1113 is provided between a case top 1160a and a case bottom 1160b. Case top 1160a has a hole to expose magnet 1114, while case bottom 1160b is closed. Printed circuit board 1113 can be flexible and integral with flexible arm 1150, or rigid and made from a separate material than flexible arm 1150. A top trace 1124 is provided between flexible arm 1150 and magnet 1114, with magnet 1114 being bonded directly to top trace 1124. In another embodiment, magnet 1114 can be electrically connected to top trace 1124 via a pin, such as is described with respect to FIG. 8. Top trace 1124 connects further with a contact pad (not shown), and from there to a trace of a second printed circuit board (not shown), such as second printed circuit board 35a of FIGS. 3 and 4. The second printed circuit board further connects to the pin of a driver circuit,

Again, bidirectional arrow 1136 indicates that the mounting of magnet 1114 on flexible arm 1150 comprises a floating characteristic, wherein the exact location of magnet 1114 after coupling with another magnet (not shown) can vary in the z-direction (by at least 1 mm, in one embodiment). The location or position of magnet 1114 can also vary slightly in the x- and y-directions, due in part to the flexible characteristic of flexible arm 1150. To prevent jamming of magnet 1114 due to unwanted angular movement, it is contemplated that a ring of material can be provided connecting flexible arm 1150 to other flexible arms (not shown) of the magnetic contacting array, such as is shown and described with respect to FIG. 5B.

The potential for substantial adjustments of magnet 1114 in the z-direction supports an adaptive magnetic contacting array which can adjust to manufacturing tolerances observed in device 1131, for example. Accordingly, good electrical contact can be provided between stacked devices, as shown in FIGS. 3 and 4, supporting currents of at least 2 amperes and data rates of at least 400 Mbps, in one example.

A water seal 1170 is provided between flexible printed circuit board 1113 and case top 1160a, as well as between flexible printed circuit board 1113 and case bottom 1160b in this embodiment. Water seal 1170 can provide a barrier between any fluid entering case top 1160a and case top 1160b and any mechanical, electrical or magnetic components, such as the electronic components of the magnetic contacting array comprising a memory, processor and driver shown in FIG. 4. However, it is contemplated that water seal 1170 can be omitted in other embodiments.

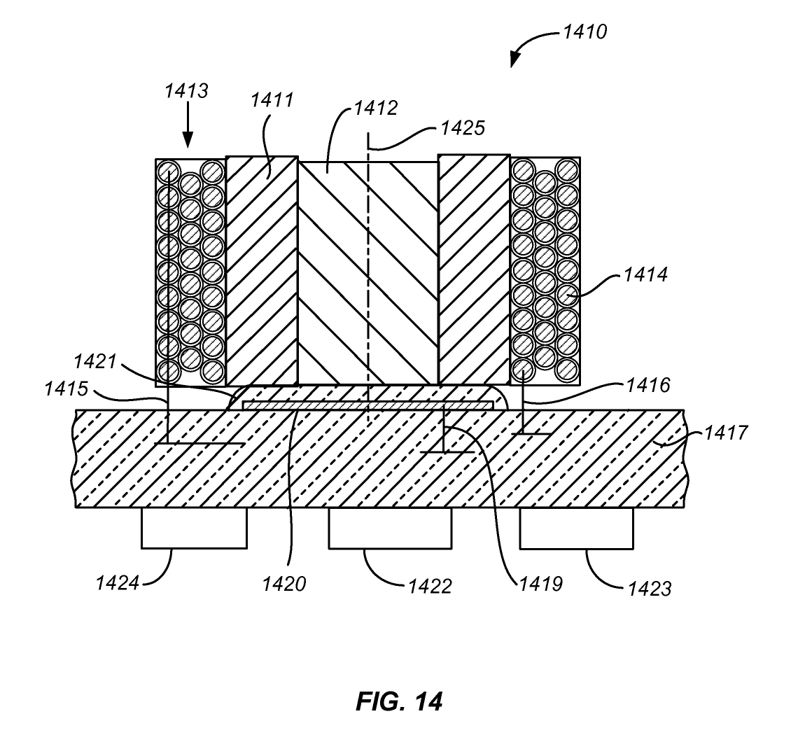

FIG. 12 is a top view of a magnetic contacting array 1210. Contact pads 1219 are positioned at an outer edge of flexible printed circuit board 1213. Elements 1214, 1281, 1282, 1283, 1284, 1285 and 1286 are positioned inward of contact pads 1219 on flexible printed circuit board 1213. In this embodiment, elements 1214, 1281, 1282, 1283, 1284, 1285 and 1286 do not necessarily have to be magnets, and can be any functional or nonfunctional element. For example, element 1214 can be a dynamic magnet; element 1281 can be a passive magnet; element 1282 can be an LED; element 1283 can be a photodiode; element 1284 can be an insulator; element 1285 can be a covered magnet; and element 1286 can be an electrode. In one embodiment, any or all of elements 1214, 1281, 1282, 1283, 1842, 1285 and 1286 are releasable magnetic devices as described herein with respect to FIGS. 14-17. Other alternatives for elements 1214, 1281, 1282, 1283, 1284, 1285 and 1286 include push/pull switches, through holes for gas or liquid flow, sensors, and/or any elements that allow electromagnetic waves or signals to flow or pass out of the magnetic contacting array 1210 or the elements connected to the magnetic contacting array 1210.

It is contemplated that the embodiment described with respect to FIG. 12 can be combined with any of the other embodiments described herein. For example, it is contemplated that any of the magnets shown and described with respect to other embodiments can be replaced with any of the alternatives described with respect to FIG. 12.

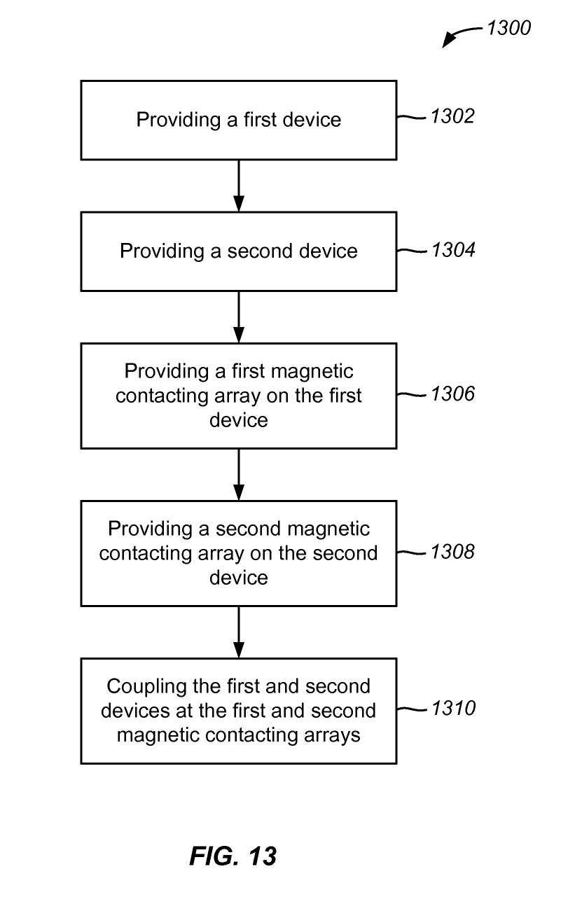

FIG. 13 depicts a flow chart 1300 describing a method for attaching devices that comprise any of the magnetic contacting arrays described herein. At step 1302, a first device is provided. At step 1304, a second device is provided. At step 1306, a first magnetic contacting array is provided on the first device. The first magnetic contacting array can be any of the magnetic contacting arrays described herein.

In one embodiment, the first magnetic contacting array comprises a flexible printed circuit board; first, second, third and fourth pluralities of contact pads; and a plurality of magnets. The first plurality of contact pads are arrayed on a first surface of the flexible printed circuit board, and the plurality of magnets are electrically attached to the first plurality of contact pads. The second plurality of contact pads match the first plurality of contact pads and are arrayed on a second surface of the printed circuit board. In one embodiment, the first plurality of contact pads are electrically isolated from the second plurality of contact pads. The third plurality of contact pads are arrayed on the first surface of the flexible printed circuit board surrounding the first plurality of contact pads. The fourth plurality of contact pads match the third plurality of contact pads and are arrayed on the second surface of the printed circuit board. In one embodiment, each contact pad of the third plurality of contact pads is pairwise electrically connected with a corresponding contact pad of the fourth plurality of contact pads.

In one embodiment, the third plurality of contact pads comprises a plurality of pairs of contact pads, each comprising a left contact pad and a right contact pad. Each left contact pad electrically connects with a contact pad of the first plurality of contact pads, and each right contact pad electrically connects with a contact pad of the second plurality of contact pads.

At step 1308, a second magnetic contacting array is provided on the second device. The second magnetic contacting array can be any of the magnetic contacting arrays described herein. In one embodiment, the second magnetic contacting array matches the positioning of the first magnetic contacting array so as to make a magnetic connection between the first and second devices. In another or the same embodiment, the second magnetic contacting array matches the structure and configuration of the first magnetic contacting array.

At step 1310, the first and second devices are coupled at the magnetic contacting arrays. For coupling, the devices have a snap-on characteristic defined by the magnets of the magnetic contacting array, and in one embodiment, by one or more magnetic, manual or mechanical locks as well, such as is described with respect to FIGS. 7A and 7B. The first and second devices can also be uncoupled at the magnetic contacting arrays. For uncoupling, a user's fingers may be used to slide the first device with respect to the second device, providing a convenient decoupling without requiring the use of either cables or tools. In other words, the magnets are very strong in the vertical direction, but are weaker and able to be separated in the orthogonal and horizontal directions.

FIG. 14 illustrates a releasable magnetic device 1410 comprising a permanent magnet 1411 configured in a tubular shape. In one embodiment, permanent magnet 11 is a neodymium magnet comprising a sintered alloy of NdFeB. In another embodiment, permanent magnet 11 is an alnico or iron-nitride magnet. Magnet 11 is “permanent” in that it is permanently magnetized, as opposed to having a magnetic field generated by an electrical current flowing into a coil wrapped around a core. Permanent magnet 11 may be plated to a thickness of around 10-20 μm with nickel, gold or nickel/copper/nickel, for example, for improved corrosion resistance and hardness protection, and may have a grade of N42M or higher for operation in a consumer electronics environment at temperatures up to 100° C. Magnet 1411 may also have a permeability of around 1.05×10⁻⁶; this property may be described as a “recoil permeability” because it is the permeability observed when a magnetized neodymium magnet is recoiled for subsequent magnetizing or demagnetizing operations. Device 1410 includes an inner core 1412 of highly permeable material such as iron or PERMALLOY, for example; core 1412 is disposed inside the tubular permanent magnet 1411 as shown. Inner core 1412 may be annealed or otherwise heat treated to increase its permeability, and a relative permeability of at least 1,000 may be achieved, as further described herein. Inner core 1412 may also be plated with nickel, gold or nickel/copper/nickel to inhibit corrosion and improve hardness.

Surrounding inner core 1412 is an excitation coil 1413 comprising wound magnet wire 1414 as shown. Although shown and described as surrounding inner core 1412, it is contemplated that excitation coil 1413 can be below, above and/or inside of permanent magnet 1411 in other embodiments and still perform the requisite functions described herein. The ends of the excitation coil 1415, 1416 are terminated in a printed circuit board 1417. Electrical continuity between permanent magnet 1411 and a corresponding termination 1419 in printed circuit board 1417 is provided via a contact pad 1420 on printed circuit board 1417 and conductive epoxy 1421. In alternative embodiments, other forms of electrical connections may be used, such as conductive clips, ultrasonic bonding, or low temperature solder. Mounted on printed circuit board 1417 are three semiconductor chips: a processor 1422, a memory 1423 and a coil driver 1424. In operation, excitation coil 1413 only has a magnetic effect when activated by a current. Memory 1423 contains instructions executable by processor 1422 to activate excitation coil 1413 by driving current through coil driver 1424. Thus, if excitation coil 1413 is not excited, device 1410 will only produce a magnetic effect corresponding to permanent magnet 1411.

Excitation coil 1413 is wound in a direction to create a magnetic field opposing the field of permanent magnet 1411, with both fields having an axial direction indicated by center line 1425. When excitation coil 1413 is excited for a brief period using a pulse of current through magnet wire 1414, the magnetic field produced by coil 1413 will exceed the magnetic field produced by permanent magnet 1411, and magnetic device 1410 will be released from an opposing magnet by magnetic repulsion. Thus, the net magnetic effect of magnetic device 1410 is temporarily reversed by excitation of coil 1413. In one embodiment, excitation coil 1413 has at least 10 turns of magnet wire 1414. Excitation coil 1413 can be automatically activated in accordance with instructions contained in the memory 1423 of the processor 1422, and/or can be activated by a user operating a switch (not shown). Although described with respect to the releasing of an opposing magnet, it is contemplated that a similar device 1410 can be used to generate a magnetic field to engage and couple magnets, or to provide for moving pins that engage magnets.

Because the relative permeability of inner core 1412 is configured to be at least 1,000 times greater than the relative permeability of permanent magnet 1411, a strong magnetic field can be produced for releasing magnetic device 1410 while having negligible effect on permanent magnet 1411. More specifically, when the same excitation field measured in amp-turns is applied simultaneously to permanent magnet 1411 and inner core 1412, the change in magnetic field in the core is 1,000 times stronger than the change in magnetic field in the permanent magnet. Neodymium magnets such as grade N42M magnets have a strong intrinsic coercive force, typically greater than 1,100 kA/m, and this protects these magnets from demagnetization due to applied magnetic fields, vibration, and elevated temperatures, among other factors.

In a miniaturized form, releasable magnetic device 1410 can have an outside diameter of 3 mm or less and a height of 2 mm or less. When operating as a contactor, releasable magnetic device 1410 can have a current carrying capacity of at least 5 amperes and a data carrying capacity of at least 400 million bits per second.

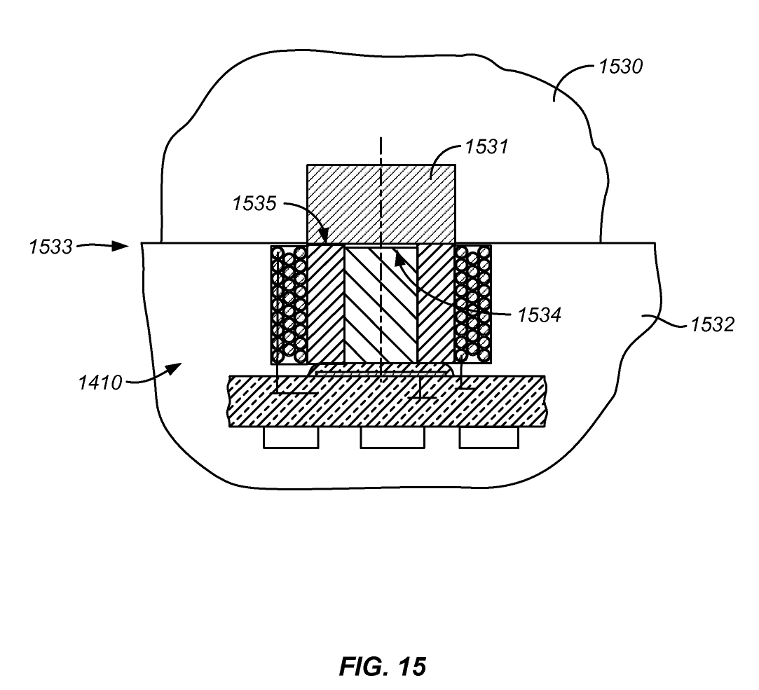

FIG. 15 depicts a device 1530 incorporating a magnet 1531 coupled with an opposing device 1532 incorporating a releasable magnetic device 1410 of a disclosed embodiment. The contact interface 1533 comprises a plane, and can be described as a planar coupling interface. Surface 1534 of magnet 1531 and surface 1535 of device 1410 as shown lying in the plane of contact interface 1533. This arrangement makes it possible to magnetically couple devices in a compact arrangement, while providing releasability of the coupling. The arrangement may be useful for coupling mobile devices, wherein compactness is desirable, and the capability of automated decoupling may be particularly useful.

Device 1530 can incorporate a releasable magnetic device, such as releasable magnetic device 1410, instead of or in addition to magnet 1531. In other words, the coupling interface may comprise releasable magnets at both sides of the interface. In another embodiment, releasable magnetic device 1410 can be opposed by a magnetic material, such as an iron disc, rather than a magnet 1531. Devices 1530 and/or 1532 can also comprise one or more manual or mechanical locks to further couple the devices together, as shown and described further herein with respect to FIGS. 7A and 7B.

In one embodiment, device 1530 is a drone device that has landed on and has become magnetically coupled to device 1532, which may be a charging and/or communication station. Device 1530 is coupled to device 1532 by the magnetic attraction between magnet 1531 and the permanent magnet 1411 of device 1532. To release device 1530 from device 1532, a signal is either automatically sent from the memory 1423 to the processor 1422 of device 1532, or a switch is activated causing a signal to be sent to the processor 1422 of device 1532. The signal indicates that the processor should drive current through the coil driver 1424 of device 1532, thereby activating the excitation coil 1413 of device 1532. The net magnetic effect of releasable magnetic device 1410 is temporarily reversed by excitation of coil 1413, for as long as current is being driven through excitation coil 1413, thereby releasing device 1530 from device 1532 by magnetic repulsion.

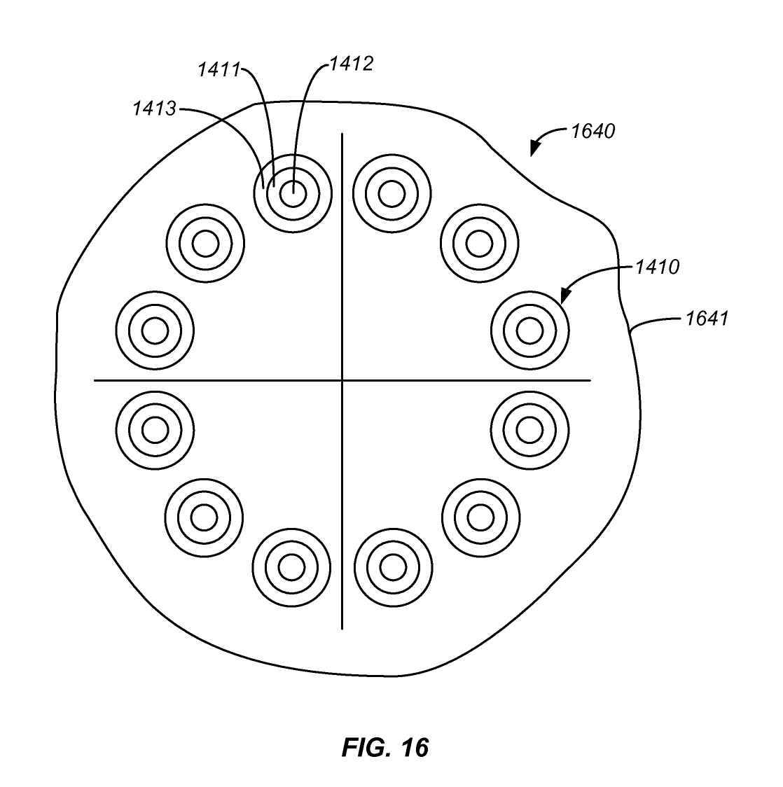

The teachings of a releasable magnetic device such as device 1410 of FIGS. 14 and 15 can be applied to a contact array comprising multiple copies of releasable magnetic device 1410, as shown in FIG. 16. A device 1640 is shown, comprising a planar attachment area 1641 and a plurality of releasable magnetic devices such as 1410. At a contact interface such as described in reference to FIG. 15, device 1640 can be opposed with a second device (not shown) having a corresponding array of magnets or magnetic devices, with pairwise coupling between each magnetic device 1410 and its corresponding magnet or magnetic device. Surface 1411 of a tubular permanent magnet may lie in the plane of planar attachment area 1641, while surface 1412 of an inner core and surface 1413 of an excitation coil may be slightly recessed from planar attachment area 1641. In another embodiment, however, all of surfaces 1411-1413 may lie in the plane of planar attachment area 1641.

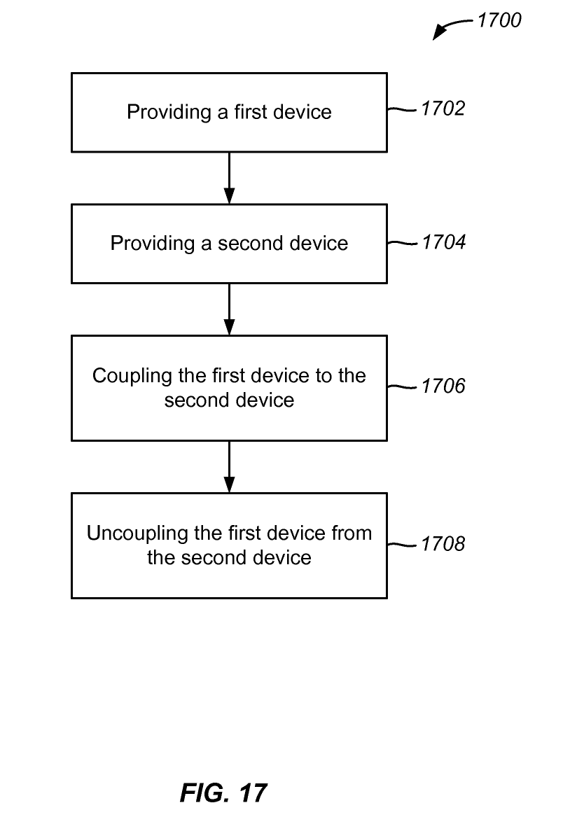

FIG. 17 is a flow chart 1700 of a method for coupling and uncoupling devices. At step 1702, a first device comprising a first magnet is provided. The first device may be, for example, device 1530 of FIG. 15. At step 1703, a second device is provided. The second device comprises a core of high permeability material, a second magnet surrounding the core of high permeability material, and an excitation coil. The second device may be, for example, device 1532 of FIG. 15.

At step 1706, the first device and the second device are coupled by magnetic attraction between the first magnet of the first device and the second magnet of the second device. At step 1708, the first device is uncoupled from the second device due to the activation of the excitation coil, which reduces the magnetic attraction between the first magnet and the excitation coil. In some embodiments, decreasing or reducing the attraction comprises creating magnetic repulsion between the first magnet of the first device and the excitation coil of the second device. In other words, the net magnetic effect of the second device is temporarily reversed by activation of the excitation coil, for as long as current is being driven through the excitation coil, thereby separating the first device from the second device by magnetic repulsion.

It is contemplated that any of the embodiments of the magnetic contacting array described herein can be implemented in conjunction with any of the embodiments of the releasable magnetic device described herein. In addition, any of the magnets shown and described with respect to the magnetic contacting arrays can be releasable magnetic devices. For example, with respect to FIG. 12, elements 1281, 1283, 1284 and 1285 can be releasable magnetic devices, while the remaining elements (e.g., elements 1214, 1282, 1286) are permanent magnets. However, when coupled to another device, the magnetic repulsion generated by releasable magnetic device elements 1281, 1283, 1284 and 1285 when their respective excitation coils are activated can be sufficient to uncouple the entire contacting array 1210 (including both the releasable magnetic devices 1281, 1283, 1284 and 1285 and the permanent magnets) from the other device. In another or the same embodiment, a single or multiple releasable magnets can be used as a lock outside of or as a part of the magnetic contacting array. In addition, all aspects of the adaptable contacting array structure described herein can be combined in any fashion with the releasable magnetic device described herein.

Further, although shown and described in particular positions and of particular sizes and shapes, it is contemplated that the various elements described herein can be in any position, can be any size, and can be any shape, while still maintaining the necessary configurations and connections for functioning as described herein. For example, with respect to FIG. 1, some or all of contact pads 19, 20 can be circular instead of square; some or all of magnets 14 can be rectangular instead of circular; and magnetic contacting array 10 can be triangular instead of circular. Further, with respect to FIGS. 14-16, inner core 1412, permanent magnet 1411, and excitation coil 1413 do not have to be tubular and can be independently selected shapes, similar or different from each other. These are merely examples of alternatives that may be implemented; however, many other alternatives are available as appreciated by one skilled in the art.

While illustrative embodiments of the application have been described in detail herein, it is to be understood that the inventive concepts may be otherwise variously embodied and employed, and that the appended claims are intended to be construed to include such variations, except as limited by the prior art.

What is claimed is:

1. A releasable magnetic device comprising:
a core of high permeability material;
a permanent magnet surrounding the core of high permeability material;
an excitation coil;
a coil driver electrically connected to the excitation coil;
a processor configured to activate the excitation coil by driving current through the coil driver; and
a memory containing instructions executable by the processor to activate the excitation coil.

2. The releasable magnetic device of claim 1, wherein the processor automatically executes the instructions to activate the excitation coil.

3. The releasable magnetic device of claim 1, further comprising:
a switch, wherein the processor is configured to execute the instructions to activate the excitation coil when the switch is activated.

4. The releasable magnetic device of claim 1, wherein the permanent magnet is tubular.

5. The releasable magnetic device of claim 1, wherein the excitation coil surrounds the permanent magnet.

6. The releasable magnetic device of claim 1, wherein activation of the excitation coil reverses a magnetic effect of the permanent magnet.

7. The releasable magnetic device of claim 1 wherein the excitation coil comprises wound magnet wire.

8. The releasable magnetic device of claim 7, wherein the magnet wire is wound in a direction to create a magnetic field opposing a magnetic field of the permanent magnet.

9. The releasable magnetic device of claim 1, further comprising a printed circuit board mounting the permanent magnet.

10. The releasable magnetic device of claim 1, wherein the permanent magnet is mounted to the printed circuit board by a contact pad.

11. A method for coupling and uncoupling devices, the method comprising:
providing a first device comprising a first magnet;
providing a second device comprising:
a core of high permeability material,
a second magnet surrounding the core of high permeability material, and
an excitation coil;
coupling the first device to the second device by magnetic attraction between the first magnet and the second magnet; and
activating the excitation coil to uncouple the first device from the second device by reducing the magnetic attraction between the first magnet and the excitation coil.

12. The method of claim 11, wherein the second device further comprises a coil driver electrically connected to the excitation coil, a processor configured to activate the excitation coil by driving current through the coil driver, and a memory containing instructions executable by the processor to activate the excitation coil.

13. The method of claim 11, wherein the excitation coil is automatically activated.

14. The method of claim 11, wherein the excitation coil is activated in response to activation of a switch.

15. The method of claim 11, wherein the permanent magnet is tubular.

16. The method of claim 11, wherein the excitation coil surrounds the permanent magnet and comprises wound magnet wire.

17. The method of claim 11, wherein reducing the magnetic attraction between the first magnet and the excitation coil comprises magnetic repulsion between the first magnet and the excitation coil.

18. The method of claim 17, wherein the magnet wire is wound in a direction to create a magnetic field opposing a magnetic field of the second magnet.

19. The method of claim 11, wherein the second device further comprises a printed circuit board mounting the second magnet.

20. The method of claim 19, wherein the second magnet is mounted to the printed circuit board by a contact pad.
